(19) United States
(12) Patent Application Publication
(10) Pub. No.: US 2009/0216932 A1
(43) Pub. Date: Aug. 27, 2009

(54) DATA PROCESSING APPARATUS

(75) Inventor: Katsuyuki KIMURA, Kamakura-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/389,822

(22) Filed: Feb. 20, 2009

(30) Foreign Application Priority Data
Feb. 21, 2008 (JP) 2008-040413

(51) Int. Cl. G06F 13/28; G06F 13/00

(52) U.S. Cl. 710/308; 710/110

(57) ABSTRACT

A data processing apparatus includes: a system bus; a processor connected to the system bus in slave connection, the processor having a command register configured to retain a DMA request command corresponding to a resource on the system bus and be accessed through the system bus; and a DMA controller connected to the system bus in bus-mastering connection, the DMA controller being configured to read out the DMA request command retained in the command register and control DMA transfer between the resource on the system bus and the processor based on the DMA request command.

### RELATED APPLICATION(S)

The present disclosure relates to the subject matter contained in Japanese Patent Application No. 2008-040413 filed on Feb. 21, 2008, which is incorporated herein by reference in its entirety.

### FIELD

The present invention relates to a data processing apparatus.

### BACKGROUND

There are many conventional multiprocessor systems which are data processing modules for performing data processing in such a manner that a plurality of processors connected to a bus to master the bus (bus mastering connection) and share the task to cooperatively operate. These systems are equipped with a core processor or a CPU (central processing unit) which controls the entire system in a unified manner and plural subprocessors which perform computation in a particular field (e.g., graphic processing or sound processing). An example of such system is disclosed in JP-A-2004-013907.

Data processing apparatus described in the document JP-A-2004-013907 has a problem, for example, that the system configuration becomes very complex when the number of subprocessors, which are in charge of computation in a particular field, connected to the bus in bus mastering connection is on the order of several dozens.

Among methods for solving the complexity of the system configuration is a method in which subprocessors having the bus mastering function being disabled with the bus mastering and being connected to a system bus in a slave connection, instructions are transferred in advance by a DMA (direct memory access) controller through slave access, and the subprocessors are allowed to operate within the limits of that scheme. However, in this method, when the subprocessors cannot deal with subject processing, overlay processing of instruction memories and other processing need to be performed with the aid of the core processor, which raises a problem that the load of the core processor is increased. Furthermore, there is no independent, general-purpose means for accessing external resources, which raises other problems that only limited information is obtained in debugging and no access means is available even in a case where the system bus has a resource available for additional subprocessors.

### SUMMARY

According to a first aspect of the invention, there is provided a data processing apparatus including: a system bus; a processor connected to the system bus in slave connection, the processor having a command register configured to retain a DMA request command corresponding to a resource on the system bus and be accessed through the system bus; and a DMA controller connected to the system bus in bus-mastering connection, the DMA controller being configured to read out the DMA request command retained in the command register and control DMA transfer between the resource on the system bus and the processor based on the DMA request command.

According to a second aspect of the invention, there is provided a data processing apparatus including: a system bus; a first processor connected to the system bus in slave connection, the first processor having a first command register configured to retain a first DMA request command corresponding to a resource on the system bus and be accessed through the system bus; a second processor connected to the system bus in slave connection, the second processor having a second command register configured to retain a second DMA request command corresponding to a resource on the system bus and be accessed through the system bus; and a DMA controller connected to the system bus in bus-mastering connection, the DMA controller being configured to (1) read out the first DMA request command retained in the first command register and control DMA transfer between the resource on the system bus and the first processor based on the first DMA request command and (2) read out the second DMA request command retained in the second command register and control DMA transfer between the resource on the system bus and the second processor based on the second DMA request command.

According to a third aspect of the invention, there is provided a data processing apparatus including: a system bus; a first processor connected to the system bus in slave connection, the first processor having a first command register configured to retain a first DMA request command corresponding to a resource on the system bus and be accessed through the system bus; a second processor connected to the system bus in slave connection, the second processor having a second command register configured to retain a second DMA request command corresponding to a resource on the system bus and be accessed through the system bus; and a DMA controller connected to the system bus in bus-mastering connection, the DMA controller being configured to (1) read out the first DMA request command retained in the first command register and control DMA transfer between the resource on the system bus and the first processor based on the first DMA request command and (2) read out the second DMA request command retained in the second command register and control DMA transfer between the resource on the system bus and the second processor based on the second DMA request command, wherein the DMA controller includes: a transfer control circuit configured to control the DMA transfer; a first transfer command generation circuit configured to receive the first DMA request command and generate a first transfer command; and a second transfer command generation circuit configured to receive the second DMA request command and generate a second transfer command.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a block diagram of a data processing apparatus according to a first embodiment of the present invention.

FIG. 2 is a block diagram of a bus interface circuit of a processor according to the first embodiment of the invention.

FIG. 3 is a block diagram of a DMA controller according to the first embodiment of the invention.

FIG. 4 is a flowchart showing the operation of the data processing apparatus according to the first embodiment of the invention.

FIG. 5 is a block diagram of a data processing apparatus according to a second embodiment of the invention.

FIG. 6 is a block diagram of a bus interface circuit of a processor according to the second embodiment of the invention.

FIG. 7 is a block diagram of a DMA controller according to the second embodiment of the invention.

FIG. 8 is a flowchart showing the operation of the data processing apparatus according to the second embodiment of the invention.

FIG. 9 is a block diagram of a data processing apparatus according to a third embodiment of the invention.

FIG. 10 is a block diagram of a DMA controller according to the third embodiment of the invention.

### DETAILED DESCRIPTION OF THE EMBODIMENT(S)

Embodiments of the present invention will now be described with reference to the accompanying drawings. In the following disclosure, common reference numerals are assigned to common components and elements throughout the drawings.

### First Embodiment

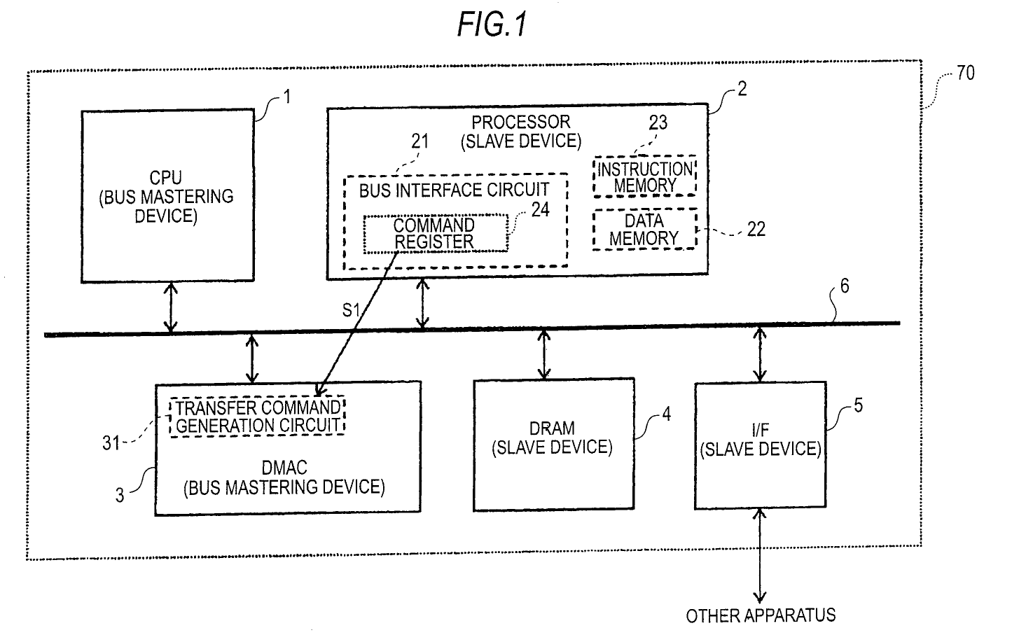

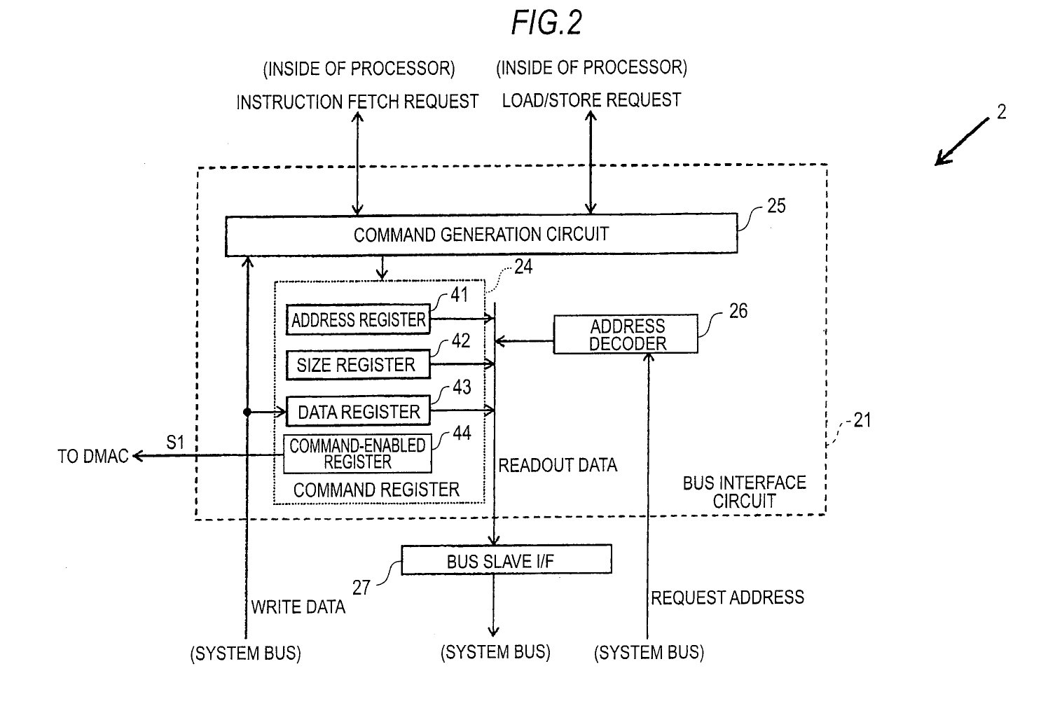

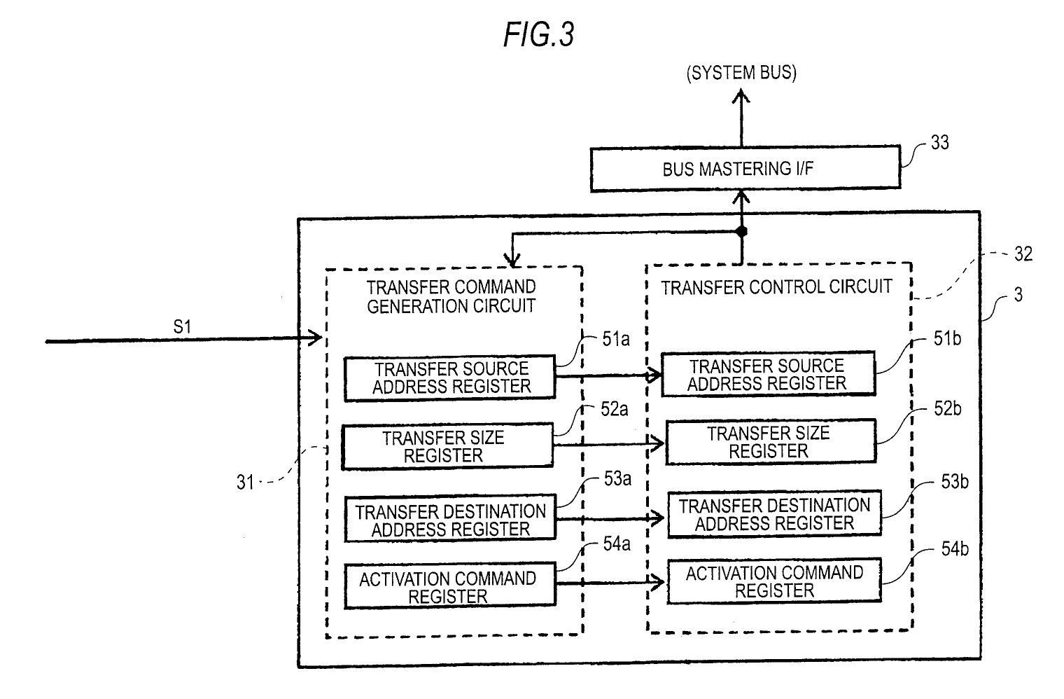

A data processing apparatus according to a first embodiment of the invention will be described below with reference to the drawings. FIG. 1 is a block diagram of the data processing apparatus. FIG. 2 is a block diagram of a bus interface circuit of a processor. FIG. 3 is a block diagram of a DMA controller. In this embodiment, the processor is used as a slave device.

As shown in FIG. 1, the data processing apparatus 70 is equipped with a CPU 1, a processor 2, a DMA controller 3, a main memory 4, an interface 5, and a system bus 6. For example, the data processing apparatus 70 as a data processing module data-processes media information such as video information, voice information, and audio information.

The CPU (central processing unit) 1 is a bus mastering device which is connected to the system bus 6 and masters the bus to control the entire data processing apparatus 70 in an organized manner. The system bus 6 may include a plurality of types of buses such as an address bus, a data bus, and a control bus.

The main memory 4 is a slave device which is slave-connected to the system bus 6 and stores, via the system bus 6, information generated in the data processing apparatus 70 and information that is transmitted from outside the data processing apparatus 70. Although in this embodiment the main memory 4 is a DRAM (dynamic random access memory), it may be an SRAM (static random access memory) or a DRAM/SRAM hybrid memory. Although in this embodiment the main memory 4 is incorporated in the data processing apparatus 70, it may be provided outside the data processing apparatus 70.

The interface 5 is a slave device which is slave-connected to the system bus 6 and which outputs information generated in the data processing apparatus 70 to an external apparatus via the system bus and receives information from an external apparatus via the system bus 6.

The processor 2 is a slave device which is slave-connected to the system bus 6. The processor 2 is also called a microprocessor, a DSP, or the like.

The processor 2 is equipped with a bus interface circuit 21, a data memory 22, and an instruction memory 23. A command register 24 provided in the bus interface circuit 21 and a transfer command generation circuit 31 provided in the DMA (direct memory access) controller 3 are connected to each other by a signal line, and an external resource request signal S1 is transmitted directly from the command register 24 to the transfer command generation circuit 31.

As shown in FIG. 2, the bus interface circuit 21 is equipped with the command register 24, a command generation circuit 25, and an address decoder 26. Write data and a request address are input to the bus interface circuit 21 via the system bus 6, and readout data is output to the system bus 6 via a bus slave interface 27.

The address decoder 26 receives and decodes a request address that is input via the system bus 6.

The command generation circuit 25 generates a request command on the basis of write data that is input via the system bus 6 and an instruction fetch request and a load/store request that occur inside the processor 2.

The command register 24 is equipped with an address register 41, a size register 42, a data register 43, and a command-enabled register 44. The command register 24 receives a request command that is output from the command generation circuit 25 and write data that is sent via the system bus 6.

When the processor 2 requires a resource on the system bus 6 (e.g., when an instruction fetch from the outside, execution of a load/store instruction, or the like has been commanded), the command register 24 retains (1) a memory address, on the system bus 6, of a necessary external resource, (2) a transfer size, and (3) an address of their transfer destination. Alternatively, the transfer destination address may be retained by the DMA controller 3.

More specifically, when an instruction fetch request has occurred inside the processor 2, the command-enabled register 44 of the command register 25 outputs an external resource request signal S1 having a DMA request command to the transfer command generation circuit 31 of the DMA controller 3. The signal line through which to transmit an external resource request signal S1 is provided between the command-enabled register 44 and the transfer command generation circuit 31. In response to the external resource request signal S1, the DMA controller 3 which has a bus mastering function causes output, via the bus slave interface 27, of data that are read from the address register 41, the size register 42, the data register 43, and the address decoder 26.

The DMA controller 3 is also a bus mastering device which is connected to the system bus 6 in bus-mastering connection to master the bus. As shown in FIG. 3, the DMA controller 3 is equipped with the transfer command generation circuit 31 and a transfer control circuit 32. The transfer control circuit 32 performs a transfer control. The transfer command generation circuit 31 receives an external resource request signal S1 having a DMA request command and generates a transfer command. A signal that is output from the DMA controller 3 is supplied to the system bus 6 via a bus mastering interface 33.

The transfer command generation circuit 31 is equipped with a transfer source address register 51a, a transfer size register 52a, a transfer destination address register 53a, and an activation command register 54a. The transfer control circuit 32 is equipped with a transfer source address register 51b, a transfer size register 52b, a transfer destination address register 53b, and an activation command register 54b.

The DMA controller 3 performs a DMA transfer corresponding to a request from the processor 2 by reading an external resource request signal S1 from the processor 2, reading a command from the processor 2 on the basis of the external resource request signal S1, and setting readout information in the transfer source address register S1a, the transfer size register 52a, and the transfer destination address register 53a of the DMA controller 3.

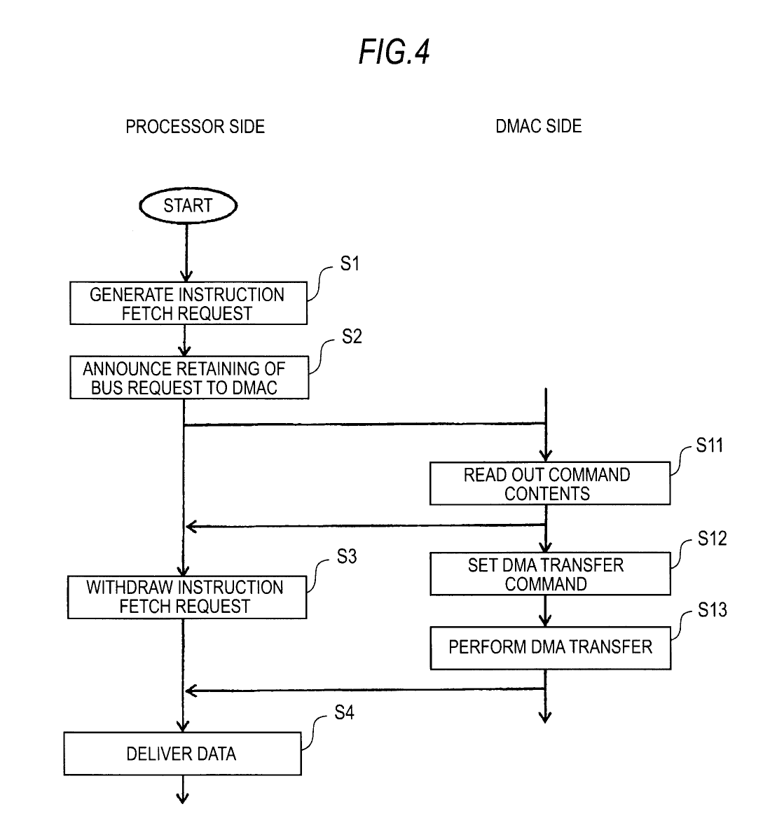

Next, the operation of the data processing apparatus 70 will be described with reference to FIG. 4. FIG. 4 is a flowchart showing the operation of the data processing apparatus 70. An example of the operation of the data processing apparatus 70 is a bus transfer to be performed when an instruction fetch request has occurred for a resource on the system bus 6.

As shown in FIG. 4, first, when information indicating a resource on the system bus 6 is input to the processor 2, at step S1 the processor 2 generates an instruction fetch request. If the instruction fetch address is “0x00000010” for example, the instruction fetch size is 8 bytes. If the address that is mapped to the processor 2 is “0x00000000,” in the bus interface circuit 21 the transfer source address, the transfer size, and the transfer destination address are converted into “0x00000010,”8 bytes, and “0x00000000,” respectively, which are retained by the command register 24.

After generating the instruction fetch request, to announce to the outside that the processor 2 is retaining a bus request, at step S2 the processor 2 writes information “enabled” to the command-enabled register 44 of the command register 24. In parallel with this operation, the processor 2 outputs, to the transfer command generation circuit 31 of the DMA controller 3, an external resource request signal S1 having a DMA request command which is a signal for announcing, to the outside, that the processor 2 is retaining a bus request.

At step S11, the DMA controller 3 receives the external resource request signal S1 (reads it from the processor 2) and judges that the processor 2 is requesting the resource on the system bus 6. To perform an actual DMA transfer, the DMA controller 3 slave-accesses the plural command registers 44 of the processor 2 via the system bus 6 using its bus mastering function and reads out the contents of the command. The DMA controller 3 announces, to the processor 2, that it has read out the command contents.

At step S3, the processor 2 recognizes that the DMA controller 3 has read out the command contents and withdraws the instruction fetch request.

At step S12, the DMA controller 3 sets the readout transfer contents as a DMA transfer command. The transfer source address, the transfer size, and the transfer destination address are “0x00000010,” 8 bytes, and “0x00000000,” respectively.

At step S13, the DMA controller 3 performs a DMA transfer on the basis of the thus-set DMA transfer command.

Since desired data is transferred by the DMA transfer, at step S4 the processor 2 delivers the data to a unit, which is the source of the instruction fetch request, inside the processor 2 itself as data (instruction) fetched into the processor 2.

The processor 2 thus finishes the instruction fetch operation on the external memory resource which was initiated by the processor 2, and the bus interface circuit 21 of the processor 2 and the DMA controller 3 are rendered in a state for waiting for the next request.

In the data processing apparatus 70, the processor 2 as a subprocessor which is slave-connected to the system bus 6 and has a relatively small circuit scale is equipped with the means for accessing an external resource. The access means allows the processor 2 to operate independently. The term “independent operation” as used herein means an operation that does not require any help from the CPU 1 etc.

This makes it possible to place a program in the main memory 4 as an external resource and to execute instructions in the main memory 4 directly. This also makes it possible to perform loading/storing on an eternal resource that is memory-mapped on the system bus 6.

As described above, the data processing apparatus 70 according to the embodiment is equipped with the CPU 1, the processor 2, the DMA controller 3, the main memory 4, the interface 5, and the system bus 6. The processor 2 is a slave device which is slave-connected to the system bus 6. The processor 2 is equipped with the bus interface circuit 21, the data memory 22, and the instruction memory 23. The command-enabled register 44 of the bus interface circuit 21 and the transfer command generation circuit 31 of the DMA controller 3 are connected to each other by the signal line. An external resource request signal S1 having a DMA request command is transmitted directly from the command register 24 of the bus interface circuit 21 to the transfer command generation circuit 31. The DMA controller 3 performs a DMA transfer corresponding to the request from the processor 2 by performing a DMA transfer control between a resource on the system bus 6 and the bus slave interface 27 of the processor 2 on the basis of the external resource request signal S1.

Therefore, the slave-connected processor 2 can operate independently without any help from the CPU 1 and execute instructions in the main memory 4 directly. Furthermore, the processor 2 can perform loading/storing on an external resource that is memory-mapped on the system bus 6. The load of the CPU 1 can thus be reduced.

In this embodiment, the CPU 1 serves as a bus mastering device which is connected to the system bus 6 to master the bus and controls the entire data processing apparatus 70 in a unified manner. However, the CPU 1 may be replaced by a core processor that serves as the bus mastering device.

### Second Embodiment

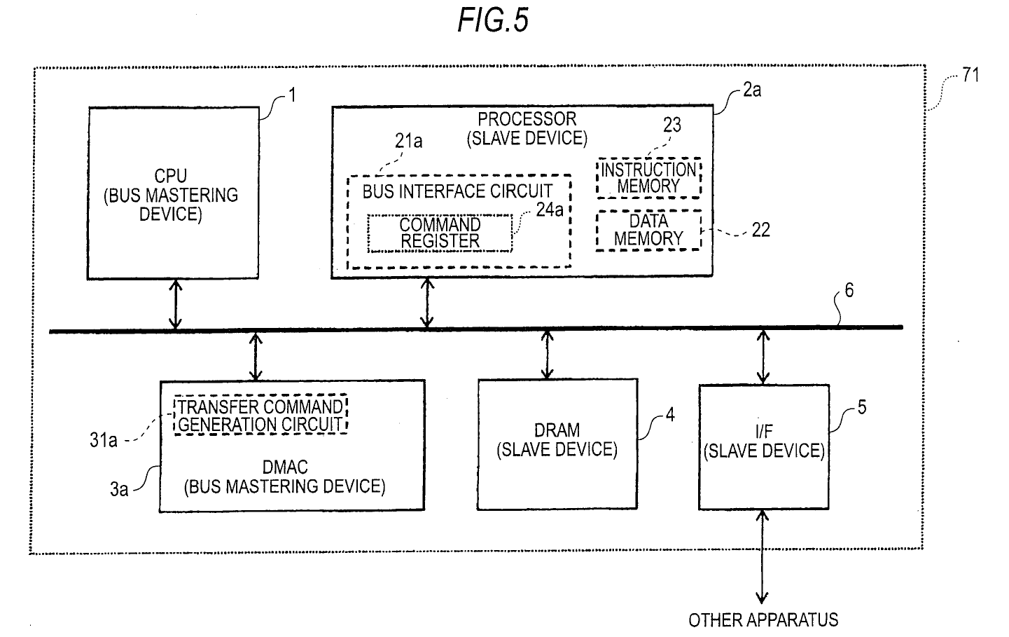

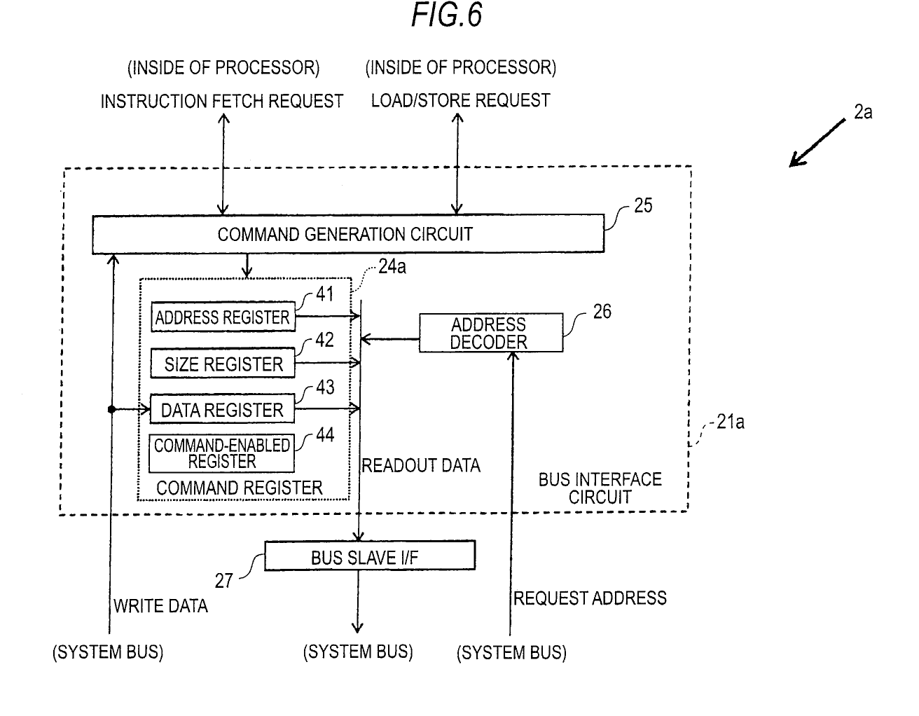

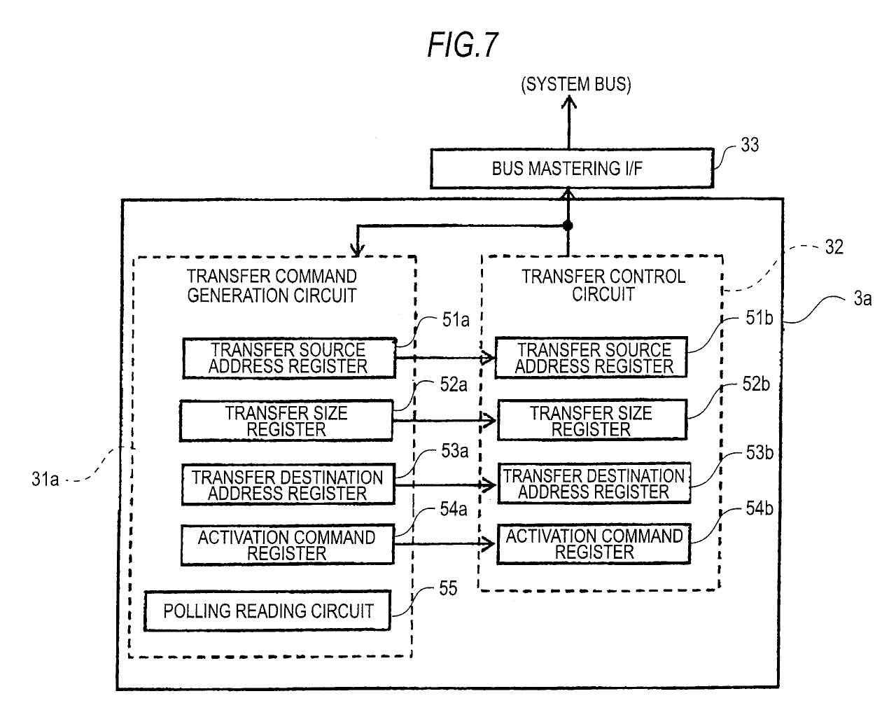

Next, a data processing apparatus according to a second embodiment of the invention will be described with reference to the drawings. FIG. 5 is a block diagram of the data processing apparatus. FIG. 6 is a block diagram of a bus interface circuit of a processor. FIG. 7 is a block diagram of a DMA controller. In this embodiment, the DMA controller performs polling reading.

In the following, the same components as in the first embodiment will be given the same symbols and will not be described, that is, only different components will be described.

As shown in FIG. 5, the data processing apparatus 71 is equipped with a CPU 1, a processor 2a, a DMA controller 3a, a main memory 4, an interface 5, and a system bus 6. For example, the data processing apparatus 71 as a data processing module data-processes media information such as video information, voice information, and audio information.

The processor 2a is a slave device which is slave-connected to the system bus 6. The processor 2a is equipped with a bus interface circuit 21a, a data memory 22, and an instruction memory 23.

As shown in FIG. 6, the bus interface circuit 21a is equipped with a command register 24a, a command generation circuit 25, and an address decoder 26. Write data and a request address are input to the bus interface circuit 21 via the system bus 6, and readout data is output to the system bus 6 via a bus slave interface 27. In this embodiment, unlike in the first embodiment, no signal line for direct transmission of a signal is provided between the command register 24a of the bus interface circuit 21a and a transfer command generation circuit 31a of the DMA controller 3a.

When the processor 2a requires a resource on the system bus 6 (e.g., when an instruction fetch from the outside, execution of a load/store instruction, or the like has been commanded), the command register 24a retains (1) a memory address, on the system bus 6, of a necessary external resource, (2) a transfer size, and (3) an address of their transfer destination.

The DMA controller 3a is also a bus mastering device which is connected to the system bus 6 to master the system bus 6. The DMA controller 3a can perform reading (polling reading) on the command register 24a of the processor 2a at given intervals even without an external resource request signal S1 which is used in the first embodiment.

As shown in FIG. 7, the DMA controller 3a is equipped with the transfer command generation circuit 31a and a transfer control circuit 32. The transfer command generation circuit 31a generates a transfer command. The transfer control circuit 32 performs a transfer control. A signal that is output from the DMA controller 3a is supplied to the system bus 6 via a bus mastering interface 33.

The transfer command generation circuit 31a is equipped with a transfer source address register 51a, a transfer size register 52a, a transfer destination address register 53a, an activation command register 54a, and a polling reading circuit 55. The polling reading circuit 55 performs reading (polling reading) on the command register 24a of the processor 2a at given intervals.

The DMA controller 3 performs a DMA transfer corresponding to a request from the processor 2a by performing reading on the command register 24a of the processor 2a until a command is written to it and setting readout information in the transfer source address register 51a, the transfer size register 52a, and the transfer destination address register 53a of the DMA controller 3a.

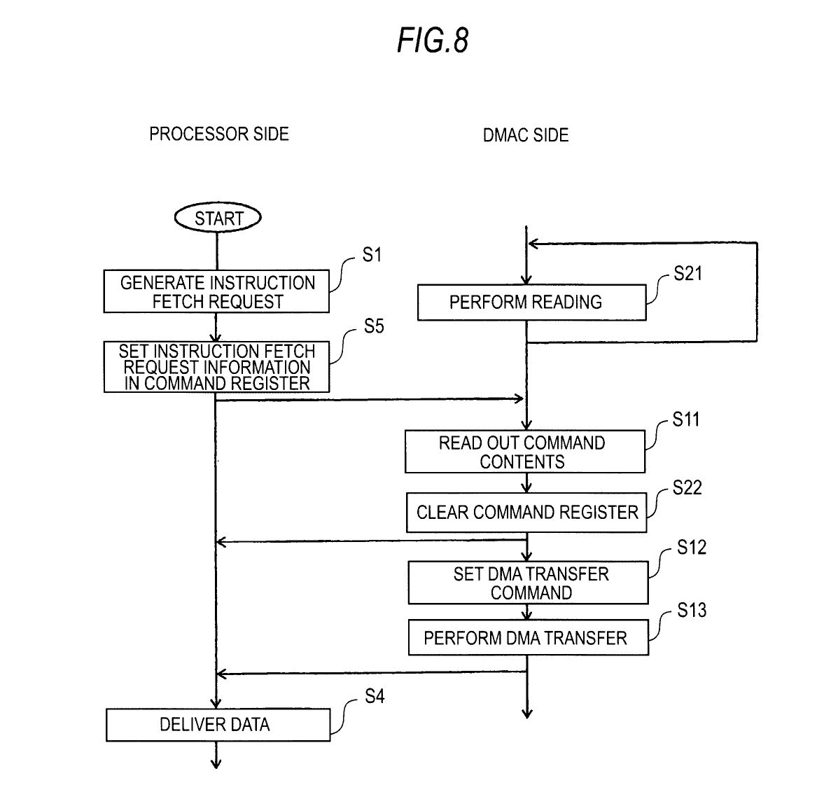

Next, the operation of the data processing apparatus 71 will be described with reference to FIG. 8. FIG. 8 is a flowchart showing the operation of the data processing apparatus 71.

As shown in FIG. 8, first, at step S21, the DMA controller 3a performs reading on the command register 24a of the processor 2a at given intervals until a desired command is written to it.

When information indicating a resource on the system bus 6 is input to the processor 2a, at step S1 the processor 2a generates an instruction fetch request. If the instruction fetch address is “0x00000010,” for example, the instruction fetch size is 8 bytes. If the address that is mapped to the processor 2 is “0x00000000,” in the bus interface circuit 21a the transfer source address, the transfer size, and the transfer destination address are converted into “0x00000010,” 8 bytes, and “0x00000000,” respectively, which are retained by the command register 24a.

After generating the instruction fetch request, at step S5 the processor 2a sets instruction fetch request information in the command register 24a. This information is communicated to the DMA controller 3a via the system bus 6.

The DMA controller 3a recognizes that the processor 2a is retaining the request. To perform an actual DMA transfer, at step S11 the DMA controller 3a reads out the contents of the command via the system bus 6 using its bus mastering function.

At step S22, the DMA controller 3a clears the command in the command register 24a of the processor 2a.

The following steps (step S12 and the following steps) are the same as in the first embodiment and hence will not be described.

In the data processing apparatus 71, the DMA controller 3a is equipped with the polling reading circuit 55 which performs reading on the command register 24a at given intervals.

As a result, the processor 2a as a subprocessor which has a relatively small circuit scale is allowed to operate independently. It becomes possible to place a program in the main memory 4 as an external resource and to execute instructions in the main memory 4 directly. It also becomes possible to perform loading/storing on an eternal resource that is memory-mapped on the system bus 6.

As described above, the data processing apparatus 71 according to the embodiment is equipped with the CPU 1, the processor 2a, the DMA controller 3a, the main memory 4, the interface 5, and the system bus 6. The processor 2a is a slave device which is slave-connected to the system bus 6. The processor 2a is equipped with the bus interface circuit 21a, the data memory 22, and the instruction memory 23. The DMA controller 3a is equipped with the polling reading circuit 55 which performs reading on the command register 24a of the processor 2a at given intervals. The DMA controller 3 performs a DMA transfer corresponding to a request from the processor 2a by performing a DMA transfer control between a resource on the system bus 6 and the bus slave interface 27 of the processor 2 on the basis of information obtained by the paling reading.

Therefore, the slave-connected processor 2a can operate independently without any help from the CPU 1 and execute instructions in the main memory 4 directly. Furthermore, the processor 2a can perform loading/storing on an external resource that is memory-mapped on the system bus 6. The load of the CPU 1 can thus be reduced.

### Third Embodiment

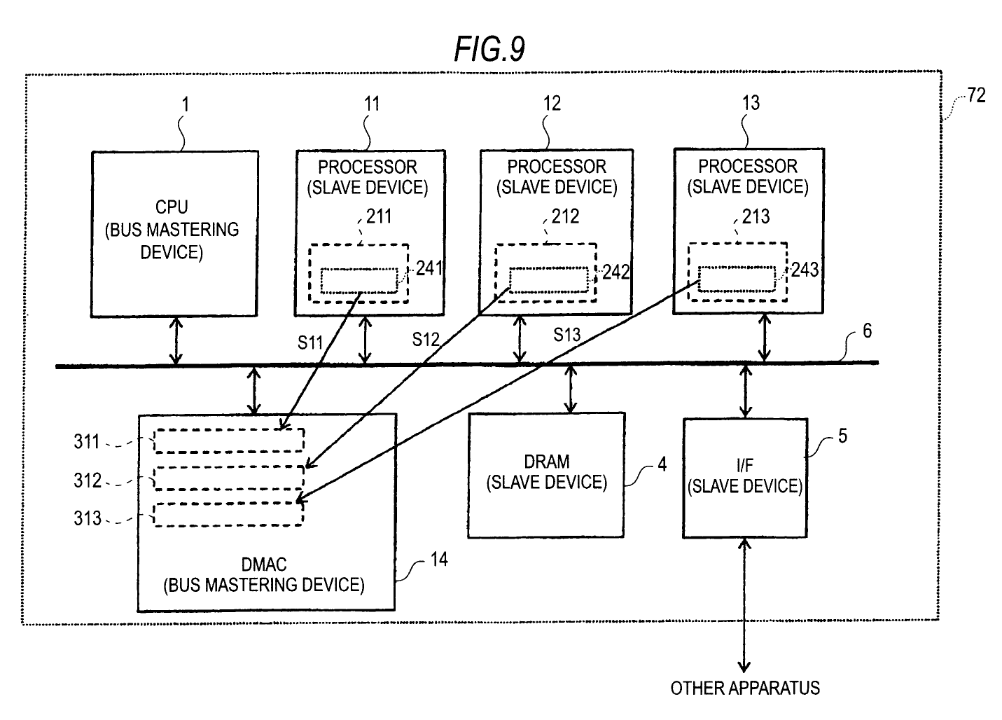

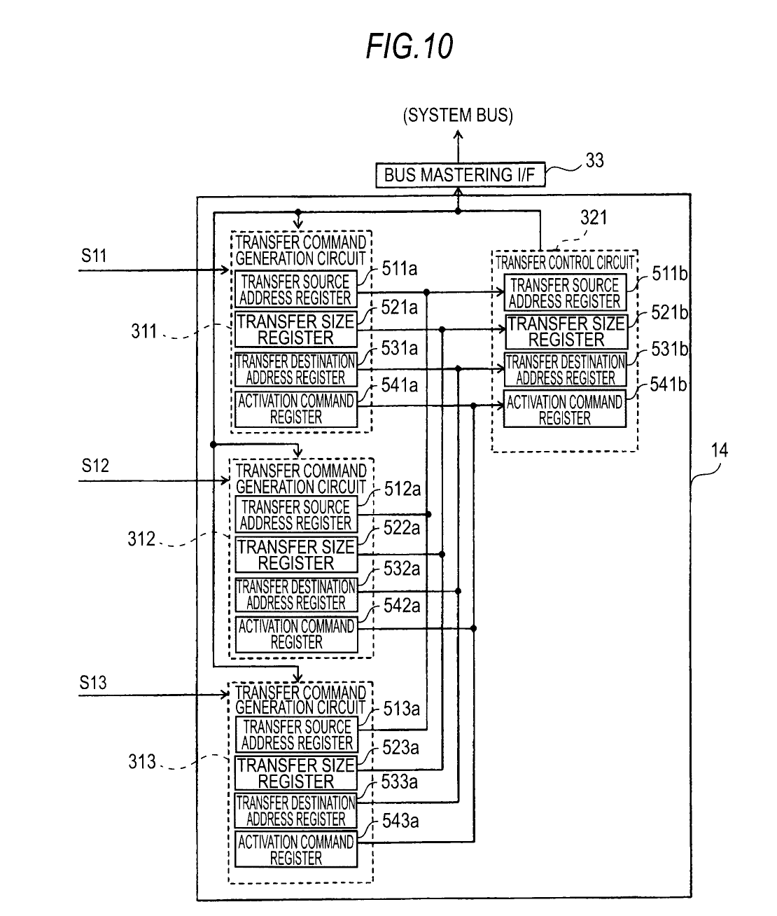

Next, a data processing apparatus according to a third embodiment of the invention will be described with reference to the drawings. FIG. 9 is a block diagram of the data processing apparatus. FIG. 10 is a block diagram of a DMA controller. In this embodiment, plural slave-connected processors are provided.

In the following, the same components as in the first embodiment will be given the same symbols and will not be described, that is, only different components will be described.

The data processing apparatus 72 is equipped with a CPU 1, processors 11-13, a DMA controller 14, a main memory 4, an interface 5, and a system bus 6. For example, the data processing apparatus 72 as a data processing module data-processes media information such as video information, voice information, and audio information.

Each of the processors 11-13 is a slave device which is slave-connected to the system bus 6. As in the first embodiment, each of the processors 11-13 is equipped with a data memory and an instruction memory (not shown), which will not be described in this embodiment.

The processor 11 is equipped with a bus interface circuit 211. A command-enabled register (not shown) of a command register 241 provided in the bus interface circuit 211 and a transfer command generation circuit 311 provided in the DMA controller 14 are connected to each other by a signal line, and an external resource request signal S11 is transmitted directly from the command register 241 to the transfer command generation circuit 311.

The processor 12 is equipped with a bus interface circuit 212. A command-enabled register (not shown) of a command register 242 provided in the bus interface circuit 212 and a transfer command generation circuit 312 provided in the DMA controller 14 are connected to each other by a signal line, and an external resource request signal S12 is transmitted directly from the command register 242 to the transfer command generation circuit 312.

The processor 13 is equipped with a bus interface circuit 213. A command-enabled register (not shown) of a command register 243 provided in the bus interface circuit 213 and a transfer command generation circuit 313 provided in the DMA controller 14 are connected to each other by a signal line, and an external resource request signal S13 is transmitted directly from the command register 243 to the transfer command generation circuit 313.

The DMA controller 14 is a bus mastering device which is connected to the system bus 6 to master the system bus 6. As shown in FIG. 10, the DMA controller 14 is equipped with the transfer command generation circuits 311-313 and a transfer control circuit 321.

The transfer control circuit 321 performs a transfer control. The transfer command generation circuit 311 receives an external resource request signal S11 having a DMA request command from the processor 11 and generates a transfer command. The transfer command generation circuit 312 receives an external resource request signal S12 having a DMA request command from the processor 12 and generates a transfer command. The transfer command generation circuit 313 receives an external resource request signal S13 having a DMA request command from the processor 13 and generates a transfer command.

The transfer control circuit 321 is equipped with a transfer source address register 511b, a transfer size register 521b, a transfer destination address register 531b, and an activation command register 541b.

The transfer command generation circuit 311 is equipped with a transfer source address register 511a, a transfer size register 521a, a transfer destination address register 531a, and an activation command register 541a. The transfer command generation circuit 312 is equipped with a transfer source address register 512a, a transfer size register 522a, a transfer destination address register 532a, and an activation command register 542a. The transfer command generation circuit 313 is equipped with a transfer source address register 513a, a transfer size register 523a, a transfer destination address register 533a, and an activation command register 543a.

When a resource request for the processor 11 occurs on the system bus 6 for the processor 11, the DMA controller 14 performs a DMA transfer corresponding to a request from the processor 11 by reading an external resource request signal S11 from the processor 11, reading a command from the processor 11 on the basis of the external resource request signal S11, and setting readout information in the transfer source address register 511a, the transfer size register 521a, and the transfer destination address register 531a of the DMA controller 14.

When a resource request occurs on the system bus 6 for the processor 12, the DMA controller 14 performs a DMA transfer corresponding to a request from the processor 12 by reading an external resource request signal S12 from the processor 12, reading a command from the processor 12 on the basis of the external resource request signal S12, and setting readout information in the transfer source address register 512a, the transfer size register 522a, and the transfer destination address register 532a of the DMA controller 14.

When a resource request occurs on the system bus 6 for the processor 13, the DMA controller 14 performs a DMA transfer corresponding to a request from the processor 13 by reading an external resource request signal S13 from the processor 13, reading a command from the processor 13 on the basis of the external resource request signal S13, and setting readout information in the transfer source address register 513a, the transfer size register 523a, and the transfer destination address register 533a of the DMA controller 14.

In the data processing apparatus 72, each of the processors 11-13 as a subprocessor which is slave-connected to the system bus 6 and has a relatively small circuit scale is equipped with the means for accessing an external resource. The access means allows each of the processors 11-13 to operate independently.

This makes it possible to place a program in the main memory 4 as an external resource and to execute instructions in the main memory 4 directly. This also makes it possible to perform loading/storing on an eternal resource that is memory-mapped on the system bus 6.

As described above, the data processing apparatus 72 according to the embodiment is equipped with the CPU 1, the processors 11-13, the DMA controller 14, the main memory 4, the interface 5, and the system bus 6. The processors 11-13 are slave devices which are slave-connected to the system bus 6. The command-enabled register of the bus interface circuit 211 of the processor 11 and the transfer command generation circuit 311 of the DMA controller 14 are connected to each other by the signal line. An external resource request signal S11 having a DMA request command is transmitted directly from the command register 241 of the bus interface circuit 211 to the transfer command generation circuit 311. The command-enabled register of the bus interface circuit 212 of the processor 12 and the transfer command generation circuit 312 of the DMA controller 14 are connected to each other by the signal line. An external resource request signal S12 having a DMA request command is transmitted directly from the command register 242 of the bus interface circuit 212 to the transfer command generation circuit 312. The command-enabled register of the bus interface circuit 213 of the processor 13 and the transfer command generation circuit 313 of the DMA controller 14 are connected to each other by the signal line. An external resource request signal S13 having a DMA request command is transmitted directly from the command register 243 of the bus interface circuit 213 to the transfer command generation circuit 312. The DMA controller 14 performs a DMA transfer corresponding to the request from the processor 11 by performing a DMA transfer control between a resource on the system bus 6 and the bus slave interface of the processor 11 on the basis of the external resource request signal S11. The DMA controller 14 performs a DMA transfer corresponding to the request from the processor 12 by performing a DMA transfer control between a resource on the system bus 6 and the bus slave interface of the processor 12 on the basis of the external resource request signal S12. The DMA controller 14 performs a DMA transfer corresponding to the request from the processor 13 by performing a DMA transfer control between a resource on the system bus 6 and the bus slave interface of the processor 13 on the basis of the external resource request signal S13.

Therefore, each of the slave-connected processors 11-13 can operate independently without any help from the CPU 1 and execute instructions in the main memory 4 directly. Furthermore, each of the processors 11-13 can perform loading/storing on an external resource that is memory-mapped on the system bus 6. The load of the CPU 1 can thus be reduced. Still further, the single DMA controller 14 which performs a DMA transfer can handle the three slave-connected processors 11-13. The number of bus mastering devices connected to the system bus 6 can thus be reduced.

In the above described embodiments, the system bus is equipped with plural buses such as the address bus, the data bus, and the control bus. For example, a configuration is possible in which the system bus is divided into a main bus and a local bus, the CPU and the DMA controller, which are bus mastering devices, are connected to the main bus, and the subprocessor(s), the main memory, and the interface, which are slave devices, are connected to the local bus (the DMA controller is also connected to the local bus). Although the third embodiment employs the three processors being in slave connection, the invention is not limited to such a case. Two slave-connected processors or four or more processors in slave connection may be provided.

It is to be understood that the present invention is not limited to the specific embodiments described above and that the present invention can be embodied with the components modified without departing from the spirit and scope of the present invention. The present invention can be embodied in various forms according to appropriate combinations of the components disclosed in the embodiments described above. For example, some components may be deleted from the configurations as described as the embodiments. Further, the components in different embodiments may be used appropriately in combination.

What is claimed is:

1. A data processing apparatus comprising:
a system bus;
a processor connected to the system bus in slave connection, the processor having a command register configured to retain a DMA request command corresponding to a resource on the system bus and be accessed through the system bus; and
a DMA controller connected to the system bus in bus-mastering connection, the DMA controller being configured to read out the DMA request command retained in the command register and control DMA transfer between the resource on the system bus and the processor based on the DMA request command.

2. The apparatus according to claim 1 further comprising a signal line configured to connect the processor and the DMA controller and transfer the DMA request command from the processor to the DMA controller.

3. The apparatus according to claim 1, wherein the command register is further configured to retain a bus access request command, and
wherein the DMA controller reads out the bus access request retained in the command register at a given interval.

4. The apparatus according to claim 1, wherein the processor comprises a bus slave interface configured to output and receive data to and from the system bus.

5. The apparatus according to claim 1, wherein the DMA controller comprises a bus master interface configured to output data and commands to the system bus.

6. The apparatus according to claim 1, wherein the DMA controller comprises a transfer command generation circuit configured to generate a transfer command based on the DMA request command read out from the command register.

7. The apparatus according to claim 6, wherein the DMA controller comprises a transfer control circuit configured to control the DMA transfer based on the transfer command generated by the transfer command generation circuit.

8. The apparatus according to claim 6, wherein the transfer command generation circuit comprises a transfer source address register.

9. The apparatus according to claim 6, wherein the transfer command generation circuit comprises a transfer size register.

10. The apparatus according to claim 6, wherein the transfer command generation circuit comprises a transfer destination address register.

11. The apparatus according to claim 6, wherein the transfer command generation circuit comprises an activation command register.

12. The apparatus according to claim 7, wherein the transfer control circuit comprises a transfer source address register.

13. The apparatus according to claim 7, wherein the transfer control circuit comprises a transfer size register.

14. The apparatus according to claim 7, wherein the transfer control circuit comprises a transfer destination address register.

15. The apparatus according to claim 7, wherein the transfer control circuit comprises an activation command register.

16. A data processing apparatus comprising:
a system bus;
a first processor connected to the system bus in slave connection, the first processor having a first command register configured to retain a first DMA request command corresponding to a resource on the system bus and be accessed through the system bus;
a second processor connected to the system bus in slave connection, the second processor having a second command register configured to retain a second DMA request command corresponding to a resource on the system bus and be accessed through the system bus; and
a DMA controller connected to the system bus in bus-mastering connection, the DMA controller being configured to (1) read out the first DMA request command retained in the first command register and control DMA transfer between the resource on the system bus and the first processor based on the first DMA request command and (2) read out the second DMA request command retained in the second command register and control DMA transfer between the resource on the system bus and the second processor based on the second DMA request command.

17. The apparatus according to claim 16, wherein the DMA controller comprises:
a transfer control circuit configured to control the DMA transfer;
a first transfer command generation circuit configured to receive the first DMA request command and generate a first transfer command; and
a second transfer command generation circuit configured to receive the second DMA request command and generate a second transfer command.

18. The apparatus according to claim 16 further comprising signal lines configured to respectively connect the first processor and the second processor to the DMA controller and transfer the first DMA request command and the second DMA request command from the first processor and the second processor to the DMA controller.

19. The apparatus according to claim 16, wherein the first command register and the second register are further configured to retain a bus access request command, and
wherein the DMA controller sequentially reads out the bus access request retained in the first command register and the second command register at a given interval.

20. A data processing apparatus comprising:
a system bus;
a first processor connected to the system bus in slave connection, the first processor having a first command register configured to retain a first DMA request command corresponding to a resource on the system bus and be accessed through the system bus;
a second processor connected to the system bus in slave connection, the second processor having a second command register configured to retain a second DMA request command corresponding to a resource on the system bus and be accessed through the system bus; and
a DMA controller connected to the system bus in bus-mastering connection, the DMA controller being configured to (1) read out the first DMA request command retained in the first command register and control DMA transfer between the resource on the system bus and the first processor based on the first DMA request command and (2) read out the second DMA request command retained in the second command register and control DMA transfer between the resource on the system bus and the second processor based on the second DMA request command,
wherein the DMA controller comprises:
a transfer control circuit configured to control the DMA transfer;
a first transfer command generation circuit configured to receive the first DMA request command and generate a first transfer command; and
a second transfer command generation circuit configured to receive the second DMA request command and generate a second transfer command.
